(19) United States
(12) Patent Application Publication
(10) Pub. No.: US 2026/0202729 A1
(43) Pub. Date: Jul. 16, 2026

(54) OPTICAL MODULE

(71) Applicant: SEIKO EPSON CORPORATION, Tokyo (JP)

(72) Inventor: Masanori YASUDA, MATSUMOTO-SHI (JP)

(21) Appl. No.: 19/447,408

(22) Filed: Jan. 13, 2026

(30) Foreign Application Priority Data
Jan. 14, 2025 (JP) 2025-004544

(51) Int. Cl. G03B 21/20

(52) U.S. Cl. CPC G03B 21/2073; G03B 21/2013; G03B 21/2033; G03B 21/2066; G03B 21/208

(57) ABSTRACT

An optical module according to an aspect of the present disclosure includes a first light source that outputs first light, a second light source that outputs second light, a first light guide that homogenizes in-plane illuminance of the first light, a second light guide that homogenizes in-plane illuminance of the second light, a first light-incident-side polarizer that transmits a second polarized component of the first light, a second light-incident-side polarizer that transmits a fourth polarized component of the second light, a first light modulator that modulates the second polarized component, a second light modulator that modulates the fourth polarized component, a first light-exiting-side polarizer that transmits a first polarized component but does not transmit the second polarized component, a second light-exiting-side polarizer that transmits a third polarized component but does not transmit the fourth polarized component, a light combiner that combines the first polarized component and the third polarized component with each other and outputs the combined light, and a projection system that projects the combined light. The first polarized component and the third polarized component are polarized components different from each other, and the light combiner combines the first polarized component and the third polarized component with each other based on a difference between the first polarized component and the third polarized component.

The present application is based on, and claims priority from JP Application Serial Number 2025-004544, filed Jan. 14, 2025, the disclosure of which is hereby incorporated by reference herein in its entirety.

### BACKGROUND

### 1. Technical Field

The present disclosure relates to an optical module.

### 2. Related Art

There has been a known projector including three liquid crystal panels as light modulators that generate three types of color image light, that is, what is called a three-panel projector. JP-A-2008-116780 described below discloses a projector including an illuminator that outputs linearly polarized light, a color separation/light guide system that separates the light from the illuminator into three types of color light, three liquid crystal devices that modulate the three types of color light, three sets of light-incident-side polarizers and light-exiting-side polarizers, a cross dichroic prism that combines the three types of modulated color light with one another, and a projection system that projects the combined light.

JP-A-2008-116780 is an example of the related art.

The projector disclosed in JP-A-2008-116780, however, requires the color separation/light guide system, which separates white light output from the illuminator into three types of color light, blue light, green light, and red light, to be incident on the liquid crystal panels. Furthermore, to efficiently combine the three types of modulated color light with one another by using the cross dichroic prism, it is necessary to add a phase retarder upstream of the cross dichroic prism in the optical path of a specific one of the three types of color light. The requirements described above cause a problem of an increase in the size of the projector.

### SUMMARY

An optical module according to an aspect of the present disclosure includes: a first light source configured to output first light having a first wavelength band containing a first polarized component and a second polarized component; a second light source configured to output second light having a second wavelength band different from the first wavelength band and containing a third polarized component and a fourth polarized component; a first light guide configured to guide the first light output from the first light source and homogenize in-plane illuminance of the first light; a second light guide configured to guide the second light output from the second light source and homogenize in-plane illuminance of the second light; a first light-incident-side polarizer configured to transmit the second polarized component of the first light output from the first light guide; a second light-incident-side polarizer configured to transmit the fourth polarized component of the second light output from the second light guide; a first light modulator configured to modulate the second polarized component output from the first light-incident-side polarizer based on image information; a second light modulator configured to modulate the fourth polarized component output from the second light-incident-side polarizer based on image information; a first light-exiting-side polarizer configured to transmit the first polarized component but does not transmit the second polarized component out of the light modulated by the first light modulator; a second light-exiting-side polarizer configured to transmit the third polarized component but does not transmit the fourth polarized component out of the light modulated by the second light modulator; a light combiner configured to combine the first polarized component output from the first light-exiting-side polarizer and the third polarized component output from the second light-exiting-side polarizer with each other and output the combined light; and a projection system configured to project the combined light output from the light combiner. The first polarized component and the third polarized component are polarized components different from each other, and the light combiner is configured to combine the first polarized component and the third polarized component with each other based on a difference between the first polarized component and the third polarized component.

### BRIEF DESCRIPTION OF THE DRAWINGS

FIG. 1 is a schematic configuration diagram of a projector according to an embodiment.

FIG. 2 shows the configuration of a portion from three light-incident-side polarizers to a light combiner in the projector according to the embodiment.

FIG. 3 is a diagrammatic view of a first light-incident-side polarizer, a first light modulator, and a first light-exiting-side polarizer.

FIG. 4 shows the configuration from three light-incident-side polarizers to a light combiner in a projector of related art.

### DESCRIPTION OF EMBODIMENTS

An embodiment of the present disclosure will be described below with reference to the drawings.

Note in the drawings used in the description below that a characteristic portion is enlarged for convenience in some cases for clarity of the characteristic thereof, and that the dimensional ratio and other factors of each element therefore in some cases differ from actual values.

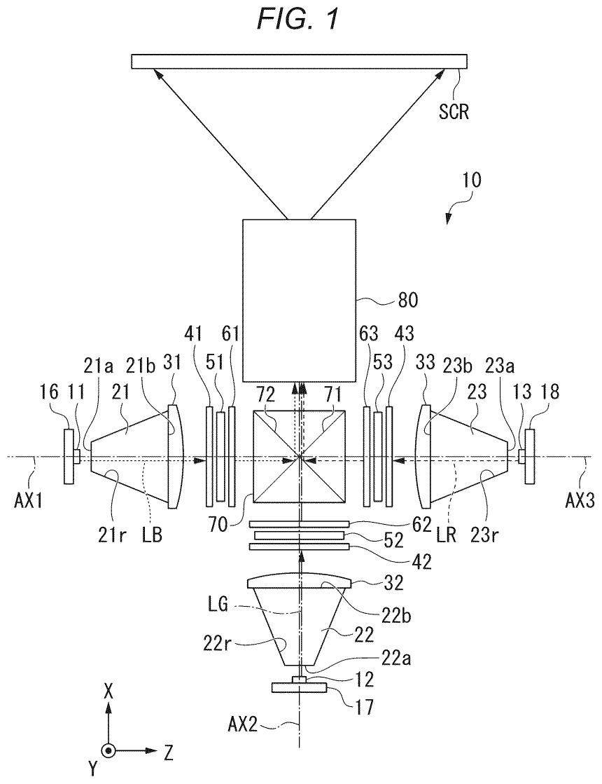

FIG. 1 is a schematic configuration diagram of a projector 10 according to the embodiment.

The projector 10 according to the present embodiment is a projection-type image display apparatus that displays a color image on a screen SCR, and is a projector including three liquid crystal panels as light modulators, that is, what is called a three-panel projector, as shown in FIG. 1. The projector 10 includes a first light source 11, a second light source 12, a third light source 13, a first light guide 21, a second light guide 22, a third light guide 23, a first parallelizing element 31, a second parallelizing element 32, a third parallelizing element 33, a first light-incident-side polarizer 41, a first light modulator 51, a first light-exiting-side polarizer 61, a second light-incident-side polarizer 42, a second light modulator 52, a second light-exiting-side polarizer 62, a third light-incident-side polarizer 43, a third light modulator 53, a third light-exiting-side polarizer 63, a light combiner 70, and a projection system 80. The projector 10 according to the present embodiment corresponds to the optical module in the claims.

In the following description, an XYZ orthogonal coordinate system is used, in which an axis corresponding to the frontward-rearward direction of the projector 10 and along the direction in which green light LG from the second light source 12 is output is defined as an X-axis, the side via which the green light LG is output is defined as a +X side, and the side opposite the +X side is defined as a −X side. An axis corresponding to the upward-downward direction of the projector 10 is defined as a Y-axis, the upper side of the projector 10 (front side of plane of view) is defined as a +Y side, and the lower side of the projector 10 (rear side of plane of view) is defined as a −Y side. An axis corresponding to the rightward-leftward direction of the projector 10 is defined as a Z-axis, the right side of the plane of view is defined as a +Z side, and the left side of the plane of view is defined as a −Z side. The optical axis of blue light LB output from the first light source 11 is defined as a first optical axis AX1, the optical axis of the green light LG output from the second light source 12 is defined as a second optical axis AX2, and the optical axis of red light LR output from the third light source 13 is defined as a third optical axis AX3.

The first light source 11 outputs the blue light LB having a blue wavelength band in the visible wavelength band at a predetermined angle of divergence. The blue wavelength band is, for example, a wavelength band ranging from 430 to 490 nm. The first light source 11 is supported by a first substrate 16. The second light source 12 outputs the green light LG having a green wavelength band in the visible wavelength band at a predetermined angle of divergence. The green wavelength band is, for example, a wavelength band ranging from 490 to 550 nm. The second light source 12 is supported by a second substrate 17. The third light source 13 outputs the red light LR having a red wavelength band in the visible wavelength band at a predetermined angle of divergence. The red wavelength band is, for example, a wavelength band ranging from 650 to 770 nm. The third light source 13 is supported by a third substrate 18. The first substrate 16, the second substrate 17, and the third substrate 18 are each made, for example, of metal, and functions as a heat dissipating member that dissipates heat generated by the corresponding light source. The blue light LB in the present embodiment corresponds to the first light having a first wavelength band in the claims. The green light LG in the present embodiment corresponds to the second light having a second wavelength band in the claims. The red light LR in the present embodiment corresponds to the third light having a third wavelength band in the claims.

The first light source 11, the second light source 12, and the third light source 13 each include a light emitting diode (LED) that emits randomly polarized light. The blue light LB output from the first light source 11 therefore contains an S-polarized component and a P-polarized component with respect to a light combining surface of the light combiner 70, which will be described later. The green light LG output from the second light source 12 includes the S-polarized component and the P-polarized component with respect to the light combining surface of the light combiner 70, which will be described later. The red light LR output from the third light source 13 contains the S-polarized component and the P-polarized component with respect to the light combining surface of the light combiner 70, which will be described later. Note that the first light source 11, the second light source 12, and the third light source 13 may each be configured with one LED or multiple LEDs. In the description below, the terms “S-polarized component” and “P-polarized component” represent polarization directions with respect to the light combining surface of the light combiner 70.

The S-polarized component of the blue light LB in the present embodiment corresponds to the first polarized component in the claims. The P-polarized component of the blue light LB in the present embodiment corresponds to the second polarized component in the claims. The P-polarized component of the green light LG in the present embodiment corresponds to the third polarized component in the claims. The S-polarized component of the green light LG in the present embodiment corresponds to the fourth polarized component in the claims. The S-polarized component of the red light LR in the present embodiment corresponds to the fifth polarized component in the claims. The P-polarized component of the red light LR in the present embodiment corresponds to the sixth polarized component in the claims.

The first light guide 21 is provided on the light exiting side of the first light source 11. The first light guide 21 is configured with a rectangular tubular frame body expanding from a light incident end 21a, on which the blue light LB is incident, toward a light exiting end 21b, via which the blue light LB exits. The light incident end 21a is a rectangular opening on the side on which the blue light LB is incident. The light exiting end 21b is a rectangular opening on the side via which the blue light LB exits. The area of the light exiting end 21b is greater than the area of the light incident end 21a. That is, the cross-sectional area of the first light guide 21 perpendicular to the first optical axis AX1 gradually increases from the light incident end 21a toward the light exiting end 21b. A frame body that constitutes the first light guide 21 is configured with a transparent member made, for example, of glass. A reflection film such as a dielectric multilayer film is formed at the inner surface of the frame body, so that the inner surface of the frame body forms a light reflecting surface 21r, which reflects the blue light. The first light guide 21 therefore functions as a rectangular tubular reflector having a tapered shape. The first light guide 21 guides the blue light LB incident via the light incident end 21a while reflecting the blue light LB off the light reflecting surface 21r and outputs the blue light LB via the light exiting end 21b to homogenize the illuminance of the blue light LB in a plane perpendicular to the first optical axis AX1.

The second light guide 22 is provided on the light exiting side of the second light source 12. The configuration and effect of the second light guide 22 are the same as the configuration and effect of the first light guide 21. The second light guide 22 guides the green light LG incident via a light incident end 22a while reflecting the green light LG off a light reflecting surface 22r and outputs the green light LG via a light exiting end 22b to homogenize the illuminance of the green light LG in a plane perpendicular to the second optical axis AX2.

The third light guide 23 is provided on the light exiting side of the third light source 13. The configuration and effect of the third light guide 23 are the same as the configuration and effect of the first light guide 21. The third light guide 23 guides the red light LR incident via a light incident end 23a while reflecting the red light LR off a light reflecting surface 23r and outputs the red light LR via a light exiting end 23b to homogenize the illuminance of the red light LR in a plane perpendicular to the third optical axis AX3.

The first parallelizing element 31 is provided at the light exiting end 21b of the first light guide 21. In the present embodiment, the first parallelizing element 31 is in contact with the light exiting end 21b of the first light guide 21. In place of the configuration described above, the first parallelizing element 31 may be separate from the light exiting end 21b of the first light guide 21. Note, however, that when the first parallelizing element 31 is in contact with the light exiting end 21b, the first parallelizing element 31 can capture the blue light LB output from the first light guide 21 at the maximum. The first parallelizing element 31 is configured with a planoconvex lens. The first parallelizing element 31 thus parallelizes the blue light LB output from the first light guide 21 at a predetermined angle of divergence. Since the blue light LB parallelized by the first parallelizing element 31 enters the liquid crystal panel that constitutes the first light modulator 51, a decrease in contrast of a blue image formed by the first light modulator 51 can be suppressed.

The second parallelizing element 32 is provided at the light exiting end 22b of the second light guide 22. The configuration and effect of the second parallelizing element 32 are the same as the configuration and effect of the first parallelizing element 31. The second parallelizing element 32 parallelizes the green light LG output from the second light guide 22 at a predetermined angle of divergence. Since the green light LG parallelized by the second parallelizing element 32 enters the liquid crystal panel that constitutes the second light modulator 52, a decrease in contrast of a green image formed by the second light modulator 52 can be suppressed.

The third parallelizing element 33 is provided at the light exiting end 23b of the third light guide 23. The configuration and effect of the third parallelizing element 33 are the same as the configuration and effect of the first parallelizing element 31. The third parallelizing element 33 parallelizes the red light LR output from the third light guide 23 at a predetermined angle of divergence. Since the red light LR parallelized by the third parallelizing element 33 enters the liquid crystal panel that constitutes the third light modulator 53, a decrease in contrast of a red image formed by the third light modulator 53 can be suppressed.

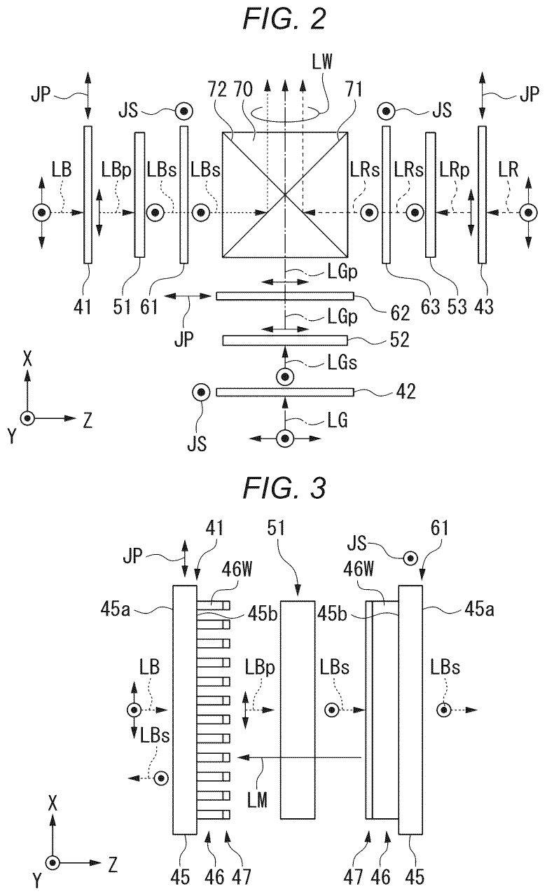

FIG. 2 shows the configuration of optical paths from the first light-incident-side polarizer 41, the second light-incident-side polarizer 42, and the third light-incident-side polarizer 43 to the light combiner 70. The first light-incident-side polarizer 41 is disposed on the light exiting side of the first parallelizing element 31, as shown in FIG. 1. The randomly polarized blue light LB output from the first light guide 21 and parallelized by the first parallelizing element 31 therefore enters the first light-incident-side polarizer 41. The first light-incident-side polarizer 41 has a transmission axis JP corresponding to a direction parallel to the plane of view of FIG. 2, that is, the polarization direction of the P-polarized component, as shown in FIG. 2. The first light-incident-side polarizer 41 therefore transmits a P-polarized component LBp of the blue light LB output from the first light guide 21.

The first light modulator 51 is disposed on the light exiting side of the first light-incident-side polarizer 41. The first light modulator 51 is configured with a transmissive liquid crystal panel. The liquid crystal panel used herein has a typical configuration in which a liquid crystal layer is sandwiched between an element substrate and a counter substrate. The first light modulator 51 modulates the P-polarized component LBp output from the first light-incident-side polarizer 41 based on blue image information. When the display method of the liquid crystal panel is a vertical alignment (VA) method, the polarization direction of the P-polarized component LBp is not rotated because no voltage is applied during black display operation, and the polarization direction of the P-polarized component LBp is rotated by 90° because a voltage is applied during white display operation, so that the P-polarized component LBp is converted into an S-polarized component LBs. Note that the display method of the liquid crystal panel is not limited to the VA method, and may be a twisted nematic (TN) method, a lateral electric field (in-plane switching: IPS) method, or the like.

The first light-exiting-side polarizer 61 is disposed on the light exiting side of the first light modulator 51. The first light-exiting-side polarizer 61 has a transmission axis JS corresponding to the direction perpendicular to the plane of view of FIG. 2, that is, the polarization direction of the S-polarized component. Therefore, the first light-exiting-side polarizer 61 transmits the S-polarized component LBs but does not transmit the P-polarized component LBp out of the light modulated by the first light modulator 51. As a result, when the P-polarized component LBp is converted into the S-polarized component LBs by the voltage application, the S-polarized component LBs passes through the first light-exiting-side polarizer 61 and is displayed in white. On the other hand, when the polarization direction of the P-polarized component LBp does not change due to no voltage application, the P-polarized component LBp cannot pass through the first light-exiting-side polarizer 61 and is displayed in black.

The first light-incident-side polarizer 41 and the first light-exiting-side polarizer 61 are each separate from the first light modulator 51. The distance between the first light-incident-side polarizer 41 and the first light modulator 51 and the distance between the first light-exiting-side polarizer 61 and the first light modulator 51 are each smaller than or equal to 13 mm. According to the configuration described above, heat generated by the first light-incident-side polarizer 41 and the first light-exiting-side polarizer 61 is unlikely to be transferred to the liquid crystal panel of the first light modulator 51, so that deterioration of the characteristics of the liquid crystal panel due to the heat can be suppressed.

When viewed along the first optical axis AX1, the first light-incident-side polarizer 41 and the first light-exiting-side polarizer 61 each overlap with a first light modulation region of the first light modulator 51. The first light modulation region is a region in which multiple pixels are arranged in a matrix and which substantially contributes to image display. It is desirable that the area of each of the first light-incident-side polarizer 41 and the first light-exiting-side polarizer 61 is equal to or greater than the area of the first light modulation region, specifically, greater than or equal to 1.0 times but smaller than or equal to 2.0 times the area of the first light modulation region. According to the configuration described above, even when the blue light LB diverges out of the first light modulation region, the function of each of the polarizers can be reliably provided, and each of the polarizers is readily held.

The second light-incident-side polarizer 42 is disposed on the light exiting side of the second parallelizing element 32, as shown in FIG. 1. The randomly polarized green light LG output from the second light guide 22 and parallelized by the second parallelizing element 32 enters the second light-incident-side polarizer 42. The second light-incident-side polarizer 42 has the transmission axis JS corresponding to the direction perpendicular to the plane of view of FIG. 2, that is, the polarization direction of the S-polarized component, as shown in FIG. 2. The second light-incident-side polarizer 42 therefore transmits an S-polarized component LGs of the green light LG output from the second light guide 22.

The second light modulator 52 is disposed on the light exiting side of the second light-incident-side polarizer 42. The configuration of the second light modulator 52 is the same as the configuration of the first light modulator 51. The second light modulator 52 modulates the S-polarized component LGs output from the second light-incident-side polarizer 42 based on green image information. When the display method of the liquid crystal panel is the VA method, the polarization direction of the S-polarized component LGs is not rotated because no voltage is applied during the black display operation, and the polarization direction of the S-polarized component LGs is rotated by 90° because a voltage is applied during the white display operation, so that the S-polarized component LGs is converted into a P-polarized component LGp.

The second light-exiting-side polarizer 62 is disposed on the light exiting side of the second light modulator 52. The second light-exiting-side polarizer 62 has the transmission axis JP corresponding to the direction parallel to the plane of view of FIG. 2, that is, the polarization direction of the P-polarized component. Therefore, the second light-exiting-side polarizer 62 transmits the P-polarized component LGp but does not transmit the S-polarized component LGs out of the light modulated by the second light modulator 52. As a result, when the S-polarized component LGs is converted into the P-polarized component LGp by the voltage application, the P-polarized component LGp passes through the second light-exiting-side polarizer 62 and is displayed in white. On the other hand, when the polarization direction of the S-polarized component LGs does not change due to no voltage application, the S-polarized component LGs cannot pass through the second light-exiting-side polarizer 62 and is displayed in black.

The second light-incident-side polarizer 42 and the second light-exiting-side polarizer 62 are each separate from the second light modulator 52. The distance between the second light-incident-side polarizer 42 and the second light modulator 52 and the distance between the second light-exiting-side polarizer 62 and the second light modulator 52 are each smaller than or equal to 13 mm. According to the configuration described above, heat generated by the second light-incident-side polarizer 42 and the second light-exiting-side polarizer 62 is unlikely to be transferred to the liquid crystal panel of the second light modulator 52, so that deterioration of the characteristics of the liquid crystal panel due to the heat can be suppressed.

When viewed along the second optical axis AX2, the second light-incident-side polarizer 42 and the second light-exiting-side polarizer 62 each overlap with a second light modulation region of the second light modulator 52. The second light modulation region is a region in which multiple pixels are arranged in a matrix and which substantially contributes to image display. It is desirable that the area of each of the second light-incident-side polarizer 42 and the second light-exiting-side polarizer 62 is equal to or greater than the area of the second light modulation region, specifically, greater than or equal to 1.0 times but smaller than or equal to 2.0 times the area of the second light modulation region. According to the configuration described above, even when the green light LG diverges out of the second light modulation region, the function of each of the polarizers can be reliably provided, and each of the polarizers is readily held.

The third light-incident-side polarizer 43 is disposed on the light exiting side of the third parallelizing element 33, as shown in FIG. 1. The randomly polarized red light LR output from the third light guide 23 and parallelized by the third parallelizing element 33 enters the third light-incident-side polarizer 43. The third light-incident-side polarizer 43 has the transmission axis JP corresponding to the direction parallel to the plane of view of FIG. 2, that is, the polarization direction of the P-polarized component, as the first light-incident-side polarizer 41, as shown in FIG. 2. The third light-incident-side polarizer 43 therefore transmits a P-polarized component LRp of the red light LR output from the third light guide 23.

The third light modulator 53 is disposed on the light exiting side of the third light-incident-side polarizer 43. The configuration of the third light modulator 53 is the same as the configuration of the first light modulator 51. The third light modulator 53 modulates the P-polarized component LRp output from the third light-incident-side polarizer 43 based on red image information. When the display method of the liquid crystal panel is the VA method, the polarization direction of the P-polarized component LRp is not rotated because no voltage is applied during the black display operation, and the polarization direction of the P-polarized component LRp is rotated by 90° because a voltage is applied during the white display operation, so that the P-polarized component LRp is converted into an S-polarized component LRs.

The third light-exiting-side polarizer 63 is disposed on the light exiting side of the third light modulator 53. The third light-exiting-side polarizer 63 has the transmission axis JS corresponding to the direction perpendicular to the plane of view of FIG. 2, that is, the polarization direction of the S-polarized component, as the first light-exiting-side polarizer 61. Therefore, the third light-exiting-side polarizer 63 transmits the S-polarized component LRs but does not transmit the P-polarized component LRp out of the light modulated by the third light modulator 53. As a result, when the P-polarized component LRp is converted into the S-polarized component LRs by the voltage application, the S-polarized component LRs passes through the third light-exiting-side polarizer 63 and is displayed in white. On the other hand, when the polarization direction of the P-polarized component LRp does not change due to no voltage application, the P-polarized component LRp cannot pass through the third light-exiting-side polarizer 63 and is displayed in black.

The third light-incident-side polarizer 43 and the third light-exiting-side polarizer 63 are each separate from the third light modulator 53. The distance between the third light-incident-side polarizer 43 and the third light modulator 53 and the distance between the third light-exiting-side polarizer 63 and the third light modulator 53 are each smaller than or equal to 13 mm. According to the configuration described above, heat generated by the third light-incident-side polarizer 43 and the third light-exiting-side polarizer 63 is unlikely to be transferred to the liquid crystal panel of the third light modulator 53, so that deterioration of the characteristics of the liquid crystal panel due to the heat can be suppressed.

When viewed along the third optical axis AX3, the third light-incident-side polarizer 43 and the third light-exiting-side polarizer 63 each overlap with a third light modulation region of the third light modulator 53. The third light modulation region is a region in which multiple pixels are arranged in a matrix and which substantially contributes to image display. It is desirable that the area of each of the third light-incident-side polarizer 43 and the third light-exiting-side polarizer 63 is equal to or greater than the area of the third light modulation region, specifically, greater than or equal to 1.0 times but smaller than or equal to 2.0 times the area of the third light modulation region. According to the configuration described above, even when the red light LR diverges out of the third light modulation region, the function of each of the polarizers can be reliably provided, and each of the polarizers is readily held.

The polarizers described above may each be made of an organic material or an inorganic material. That is, the first light-incident-side polarizer 41, the second light-incident-side polarizer 42, and the third light-incident-side polarizer 43 may each be made of an organic material. Instead, the first light-incident-side polarizer 41, the second light-incident-side polarizer 42, and the third light-incident-side polarizer 43 may each be made of an inorganic material. The first light-exiting-side polarizer 61, the second light-exiting-side polarizer 62, and the third light-exiting-side polarizer 63 may each be made of an organic material. Instead, the first light-exiting-side polarizer 61, the second light-exiting-side polarizer 62, and the third light-exiting-side polarizer 63 may each be made of an inorganic material.

When the polarizers are each made of an organic material, a polarizer having polarization performance can be produced, for example, by stretching resin such as polyvinyl alcohol. Using an organic material as the material of each of the polarizers, the production cost of the polarizer can be reduced. The thus configured polarizer may be bonded to the liquid crystal panel via an adhesive. Instead, the polarizer may be bonded to a holding member such as a glass plate and then separated from the liquid crystal panel. According to the configuration in which the polarizer is separated from the liquid crystal panel, deterioration of characteristics of the liquid crystal panel due to heat can be suppressed. When an inorganic material is used as the material of each of the polarizers, a wire grid polarizer in which multiple thin metal wires made, for example, of aluminum are formed at predetermined intervals can be used. In this case, it is desirable to separate the polarizer from the liquid crystal panel to suppress damage to the thin metal wires.

Note in the present embodiment that each of the light-incident-side polarizers and the corresponding light-exiting-side polarizer are separate from the corresponding light modulator, and that in place of the configuration described above, each of the light-incident-side polarizer and the corresponding light-exiting-side polarizer may be in contact with the corresponding light modulator. In this case, it is desirable that the first light-incident-side polarizer 41 and the first light-exiting-side polarizer 61 each overlap with the first light modulation region of the first light modulator 51 when viewed along the first optical axis AX1, the second light-incident-side polarizer 42 and the second light-exiting-side polarizer 62 each overlap with the second light modulation region of the second light modulator 52 when viewed along the second optical axis AX2, and the third light-incident-side polarizer 43 and the third light-exiting-side polarizer 63 each overlap with the third light modulation region of the third light modulator 53 when viewed along the third optical axis AX3.

It is further desirable that the area of each of the first light-incident-side polarizer 41 and the first light-exiting-side polarizer 61 is greater than or equal to 1.0 times but smaller than or equal to 1.2 times the area of the first light modulation region, the area of each of the second light-incident-side polarizer 42 and the second light-exiting-side polarizer 62 is greater than or equal to 1.0 times but smaller than or equal to 1.2 times the area of the second light modulation region, and the area of each of the third light-incident-side polarizer 43 and the third light-exiting-side polarizer 63 is greater than or equal to 1.0 times but smaller than or equal to 1.2 times the area of the third light modulation region. According to the configuration described above, even when the three types of color light diverge out of the respective light modulation regions, the function of each of the polarizers can be reliably provided, and each of the polarizers is readily held.

FIG. 3 shows a specific example of the configuration of the first light-incident-side polarizer 41, the first light modulator 51, and the first light-exiting-side polarizer 61.

In the present configuration example, the first light-incident-side polarizer 41 includes a glass plate 45, a wire grid layer 46, and a light absorbing layer 47, as shown in FIG. 3. The wire grid layer 46 has a configuration in which multiple thin wires 46W made of metal such as aluminum are formed at predetermined intervals. The wire grid layer 46 is formed at a surface 45b opposite a surface 45a, on which the blue light LB is incident, out of the two surfaces of the glass plate 45. The light absorbing layer 47 is formed at the tips of the multiple thin wires 46W. The light absorbing layer 47 is therefore disposed on a side of the wire grid layer 46 that is the side opposite the side on which the blue light LB is incident.

The first light-exiting-side polarizer 61 includes the glass plate 45, the wire grid layer 46, and the light absorbing layer 47. The first light-exiting-side polarizer 61 is configured in the same manner as the first light-incident-side polarizer 41. The orientation of the first light-exiting-side polarizer 61 is, however, opposite the orientation of the first light-incident-side polarizer 41. That is, in the first light-exiting-side polarizer 61, the light absorbing layer 47 is disposed on a side of the wire grid layer 46 that is the side on which the blue light LB is incident. The direction in which the multiple thin wires 46W extend in the first light-exiting-side polarizer 61 is perpendicular to the direction in which the multiple thin wires 46W extend in the first light-incident-side polarizer 41.

In the present configuration example, out of the randomly polarized blue light LB incident on the first light-incident-side polarizer 41, the P-polarized component LBp passes through the first light-incident-side polarizer 41, but the S-polarized component LBs is reflected off the wire grid layer 46 including the multiple thin wires 46W. The S-polarized light component LBs reflected off the wire grid layer 46 and returning toward the first light source is reflected at some locations in the path and travels toward the first light-incident-side polarizer 41 again. In the path described above, at least part of the S-polarized component LBs is converted into the P-polarized component LBp, which passes through the first light-incident-side polarizer 41 and can contribute to the display operation. Recycling at least part of the S-polarized component LBs reflected off the wire grid layer 46 as described above allows the blue light LB output from the first light source 11 to be used at increased efficiency. In the configuration described above, it is desirable to dispose a quarter-wave plate between the first light source 11 and the first light-incident-side polarizer 41. The configuration described above increases the proportion of the S-polarized component LBs converted into the P-polarized component LBp, so that the efficiency of the recycling can be increased.

Light LM, which is part of the light output from the first light-incident-side polarizer 41 and modulated by the first light modulator 51, is reflected in some cases off the first light-exiting-side polarizer 61, then passes through the first light modulator 51, and returns to the first light-incident-side polarizer 41. The light LM becomes stray light in the path from the first light-incident-side polarizer 41 to the first light-exiting-side polarizer 61, and may therefore degrade the display quality. To address the problem, the present configuration, in which the light reflected off the first light-exiting-side polarizer 61 and returning to the first light-incident-side polarizer 41 is absorbed by the light absorbing layer 47, can suppress the occurrence of the stray light. The degradation of the display quality due to the stray light can thus be suppressed.

Since the blue light has energy higher than that of the other color light, the blue light is likely to damage the polarizers. It is therefore desirable to use an inorganic material as the material of the first light-incident-side polarizer 41 and the first light-exiting-side polarizer 61, on which the blue light LB is incident, as in the example shown in FIG. 3, but the second light-incident-side polarizer 42 and the second light-exiting-side polarizer 62, on which the green light LG is incident, and the third light-incident-side polarizer 43 and the third light-exiting-side polarizer 63, on which the red light LR is incident, may each be a polarizer made of an organic material having a reflection layer. According to the configuration described above, the production cost of the entire polarizers can be suppressed while the effect of recycling the three types of color light is provided. In consideration of the energy of the light, the material of each of the polarizers may be changed in accordance with color. For example, the first light-exiting-side polarizer 61, on which the blue light LB is incident, and the second light-exiting-side polarizer 62, on which the green light LG is incident, may each be made of an inorganic material, and the third light-exiting-side polarizer 63, on which the red light LR is incident, may be made of an organic material.

The light combiner 70 is disposed on the light exiting side of the first light-exiting-side polarizer 61, the light exiting side of the second light-exiting-side polarizer 62, and the light exiting side of the third light-exiting-side polarizer 63 and at a position where the first optical axis AX1, the second optical axis AX2, and the third optical axis AX3 intersect with one another, as shown in FIG. 1. The light combiner 70 is configured with a cross dichroic prism. The light combiner 70 has a first light combining surface 71, which reflects the blue light LB and transmits the green light LG and the red light LR, and a second light combining surface 72, which reflects the red light LR and transmits the green light LG and the blue light LB. In the present specification, the first light combining surface 71 and the second light combining surface 72 are collectively referred to as light combining surfaces. A typical cross dichroic prism has reflectance (transmittance) that depends on polarization, and is so used that the blue light LB and the red light LR are caused to be incident as S-polarized light on the prism and the green light LG is caused to be incident as P-polarized light on the prism to efficiently combine the three types of color light with one another over a wide wavelength band.

The S-polarized light component LBs of the blue light LB incident on the light combiner 70 in the +Z direction passes through the second light combining surface 72, is reflected off the first light combining surface 71, and travels in the +X direction, as shown in FIG. 2. The S-polarized light component LRs of the red light LR incident on the light combiner 70 in the −Z direction passes through the first light combining surface 71, is reflected off the second light combining surface 72, and travels in the +X direction. The P-polarized component LGp of the green light LG incident on the light combiner 70 in the +X direction passes through the first light combining surface 71 and the second light combining surface 72 and travels in the +X direction. The light combiner 70 thus combines the S-polarized component LBs of the blue light LB, the P-polarized component LGp of the green light LG, and the S-polarized component LRs of the red light LR with one another based on the difference in polarization direction between the S-polarized component and the P-polarized component, and outputs combined light LW in the +X direction.

The projection system 80 is disposed on the light exiting side of the light combiner 70, as shown in FIG. 1. The projection system 80 includes multiple projection lenses. The projection system 80 projects the combined light LW output from the light combiner 70 onto the screen SCR. A full-color image is thus projected onto the screen SCR.

### Advantages of First Embodiment

The projector 10 according to the present embodiment includes the first light source 11, which outputs the blue light LB, the second light source 12, which outputs the green light LG, the third light source 13, which outputs the red light LR, the first light guide 21, which guides the blue light LB output from the first light source 11 and homogenizes the in-plane illuminance of the blue light LB, the second light guide 22, which guides the green light LG output from the second light source 12 and homogenizes the in-plane illuminance of the green light LG, the third light guide 23, which guides the red light LR output from the third light source 13 and homogenizes the in-plane illuminance of the red light LR, the first light-incident-side polarizer 41, which transmits the P-polarized component LBp of the blue light LB output from the first light guide 21, the second light-incident-side polarizer 42, which transmits the S-polarized component LGs of the green light LG output from the second light guide 22, the third light-incident-side polarizer 43, which transmits the P-polarized component LRp of the red light LR output from the third light guide 23, the first light modulator 51, which modulates the P-polarized component LBp output from the first light-incident-side polarizer 41 based on image information, the second light modulator 52, which modulates the S-polarized component LGs output from the second light-incident-side polarizer 42 based on image information, the third light modulator 53, which modulates the P-polarized component LRp output from the third light-incident-side polarizer 43 based on image information, the first light-exiting-side polarizer 61, which transmits the S-polarized component LBs but does not transmit the P-polarized component LBp out of the light modulated by the first light modulator 51, the second light-exiting-side polarizer 62, which transmits the P-polarized component LGp but does not transmit the S-polarized component LGs out of the light modulated by the second light modulator 52, the third light-exiting-side polarizer 63, which transmits the S-polarized component LRs but does not transmit the P-polarized component LRp out of the light modulated by the third light modulator 53, the light combiner 70, which combines the S-polarized component LBs output from the first light-exiting-side polarizer 61, the P-polarized component LGp output from the second light-exiting-side polarizer 62, and the S-polarized component LRs output from the third light-exiting-side polarizer 63 with one another and projects the combined light LW, and the projection system 80, which projects the combined light LW output from the light combiner 70. The light combiner 70 combines the S-polarized components LBs and LRs and the P-polarized component LGp with one another based on the difference in polarization direction between the S-polarized component and the P-polarized component.

The projector 10 according to the present embodiment includes the first light source 11, the second light source 12, and the third light source 13, which output multiple types of color light having different colors, and has the configuration in which the multiple types of color light LB, LG, and LR output from the light sources 11, 12, and 13 are caused to enter the light modulators 51, 52, and 53 via the light guides 21, 22, and 23. Therefore, the projector 10 according to the present embodiment does not require a color separation/light guide system, and can therefore be reduced in size as compared with the projector of the related art.

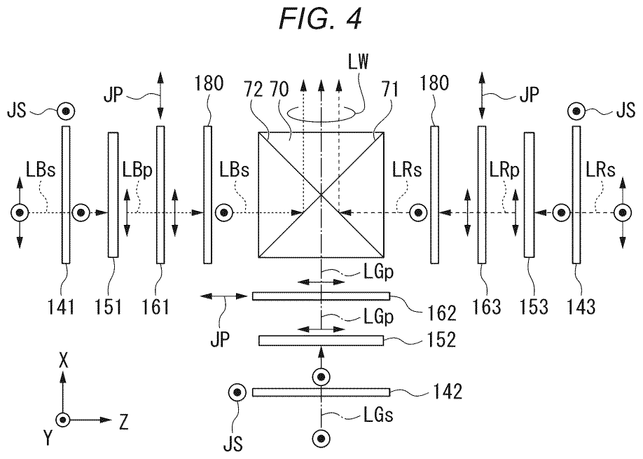

FIG. 4 shows the configuration from three light-incident-side polarizers to a light combiner in the projector of the related art.

In the projector of the related art, randomly polarized white light output from a light source is converted by a polarization converter into one type of linearly polarized light, for example, the S-polarized component, which is then separated by a color separation/light guide system into three types of color light, which are caused to enter the light modulators. To this end, the S-polarized components LBs, LGs, and LRs are incident on a first light modulator 151, a second light modulator 152, and a third light modulator 153 via light-incident-side polarizers 141, 142, and 143, as shown in FIG. 4. The S-polarized components LBs, LGs, and LRs are converted into P-polarized components LBp, LGp, and LRp by voltage application to the light modulators 151, 152, and 153 during the white display operation, and the P-polarized components LBp, LGp, and LRp pass through light-exiting-side polarizers 161, 162, and 163.

To efficiently combine the three types of color light with one another in the light combiner 70, however, it is necessary to cause S-polarized blue light and red light to enter the light combiner 70 and cause P-polarized green light to enter the light combiner 70, as described above. To this end, phase retarders 180 each configured with a half-wave plate or the like are disposed at a position downstream of the first light-exiting-side polarizer 161 in the optical path of the blue light and at a position downstream of the third light-exiting-side polarizer 163 in the optical path of the red light. The P-polarized components LBp and LRp of the blue light and the red light are thus converted by the phase retarders 180 into the S-polarized components LBs and LRs, so that the three types of color light can be efficiently combined with one another by the light combiner 70.

In contrast, the projector 10 according to the present embodiment causes the P-polarized components LBp and LRp to enter the first light modulator 51 in the optical path of the blue light LB and the third light modulator 53 in the optical path of the red light LR, and the S-polarized component LGs to enter the second light modulator 52 in the optical path of the green light LG, as shown in FIG. 2. Therefore, during the white display operation, the P-polarized components LBp and LRp are converted into the S-polarized components LBs and LRs by voltage application to the first light modulator 51 and the third light modulator 53, and the S-polarized component LGs is converted into the P-polarized component LGp by voltage application to the second light modulator 52. The three types of color light can therefore be efficiently combined with one another by the light combiner 70 without disposing the phase retarders 180 in FIG. 4 in any of the optical paths. As described above, the present embodiment, in which the phase retarders 180 are unnecessary, can further reduce the number of components to reduce the size of the projector 10. In addition, the phase retarders 180 are produced in many cases by using an organic material such as polycarbonate, and cooling is therefore required to ensure reliability of the produced phase retarders 180. In this regard, a configuration in which the phase retarders 180 are not used allows a cooler used to cool the phase retarders 180 to be used to cool other members.

Note that the technical scope of the present disclosure is not limited to the embodiment described above, and various changes can be made thereto without departing from the intent of the present disclosure.

For example, each light source may contain a phosphor that is excited by the light from an LED and emits color light. In addition to the above, the specific description of the shapes, the numbers, the arrangements, the materials, and other factors of the elements of the projector are not limited to those in the embodiment described above and can be changed as appropriate.

### Summary of Present Disclosure

The present disclosure will be summarized below as additional remarks.

### Additional Remark 1

An optical module including:
a first light source configured to output first light having a first wavelength band containing a first polarized component and a second polarized component;
a second light source configured to output second light having a second wavelength band different from the first wavelength band and containing a third polarized component and a fourth polarized component;
a first light guide configured to guide the first light output from the first light source and homogenize in-plane illuminance of the first light;
a second light guide configured to guide the second light output from the second light source and homogenize in-plane illuminance of the second light;
a first light-incident-side polarizer configured to transmit the second polarized component of the first light output from the first light guide;
a second light-incident-side polarizer configured to transmit the fourth polarized component of the second light output from the second light guide;
a first light modulator configured to modulate the second polarized component output from the first light-incident-side polarizer based on image information;
a second light modulator configured to modulate the fourth polarized component output from the second light-incident-side polarizer based on image information;
a first light-exiting-side polarizer configured to transmit the first polarized component but does not transmit the second polarized component out of the light modulated by the first light modulator;
a second light-exiting-side polarizer configured to transmit the third polarized component but does not transmit the fourth polarized component out of the light modulated by the second light modulator;
a light combiner configured to combine the first polarized component output from the first light-exiting-side polarizer and the third polarized component output from the second light-exiting-side polarizer with each other and output the combined light; and
a projection system configured to project the combined light output from the light combiner,
wherein the first polarized component and the third polarized component are polarized components different from each other, and
the light combiner is configured to combine the first polarized component and the third polarized component with each other based on a difference between the first polarized component and the third polarized component.

According to the configuration described in Additional Remark 1, which requires neither a color separation/light guide system nor phase retarders that allow the light combiner to efficiently combine the first polarized component and the third polarized component with each other, the optical module can be reduced in size.

### Additional Remark 2

The optical module according to Additional Remark 1, further including:
a third light source configured to output third light having a third wavelength band different from the first wavelength band and the second wavelength band, the third wavelength band containing a fifth polarized component and a sixth polarized component;
a third light guide configured to guide the third light output from the third light source and homogenize in-plane illuminance of the third light;
a third light-incident-side polarizer configured to transmit the sixth polarized component of the third light output from the third light guide;
a third light modulator configured to modulate the sixth polarized component output from the third light-incident-side polarizer based on image information; and
a third light-exiting-side polarizer configured to transmit the fifth polarized component but does not transmit the sixth polarized component out of the light modulated by the third light modulator,
wherein the fifth polarized component and the third polarized component are polarized components different from each other, and
the light combiner is configured to further combine the fifth polarized component with the combined light based on a difference between the fifth polarized component and the third polarized component.

According to the configuration described in Additional Remark 2, an optical module capable of projecting an image formed by the light containing the first light, the second light, and the third light can be provided.

### Additional Remark 3

The optical module according to Additional Remark 2, further including:
a first parallelizing element configured to parallelize the first light output from the first light guide;
a second parallelizing element configured to parallelize the second light output from the second light guide; and
a third parallelizing element configured to parallelize the third light output from the third light guide.

According to the configuration described in Additional Remark 3, since the multiple types of parallelized color light can be incident on the light modulators, the display quality can be increased.

### Additional Remark 4

The optical module according to additional remark 3, wherein
the first polarized component and the fifth polarized component are S-polarized light with respect to a light combining surface of the light combiner,
the third polarized component is P-polarized light with respect to the light combining surface,
the first polarized component and the fifth polarized component are reflected off the light combining surface, and
the third polarized component passes through the light combining surface.

According to the configuration described in Additional Remark 4, when a cross dichroic prism is used as the light combiner, the first polarized component, the third polarized component, and the fifth polarized component can be efficiently combined with one another, so that the multiple types of light can be used at increased efficiency.

### Additional Remark 5

The optical module according to Additional Remark 4, wherein
the first light is blue light,
the second light is green light, and
the third light is red light.

According to the configuration described in Additional Remark 5, an optical module capable of projecting a full-color image can be provided.

### Additional Remark 6

The optical module according to Additional Remark 5, wherein
the first light-exiting-side polarizer, the second light-exiting-side polarizer, and the third light-exiting-side polarizer are each made of an inorganic material.

According to the configuration described in Additional Remark 6, the heat resistance of each of the polarizers can be increased.

### Additional Remark 7

The optical module according to Additional Remark 5, wherein
the first light-exiting-side polarizer, the second light-exiting-side polarizer, and the third light-exiting-side polarizer are each made of an organic material.

According to the configuration described in Additional Remark 7, the cost of each of the polarizers can be reduced.

### Additional Remark 8

The optical module according to Additional Remark 5, wherein
the first light-exiting-side polarizer and the second light-exiting-side polarizer are each made of an inorganic material, and
the third light-exiting-side polarizer is made of an organic material.

According to the configuration described in Additional Remark 8, the cost of the polarizers as a whole can be reduced with the heat resistance of the polarizers increased.

### Additional Remark 9

The optical module according to Additional Remark 5, wherein
the first light-incident-side polarizer has a wire grid layer, and a light absorbing layer that is disposed on a side of the wire grid layer opposite a side on which the first light is incident, and
each of the second light-incident-side polarizer and the third light-incident-side polarizer has a reflection layer and is made of an organic material.

According to the configuration described in Additional Remark 9, the first light-incident-side polarizer can be used to recycle the first light so that the first light is used at improved efficiency, and suppress stray light, and the second light-incident-side polarizer and the third light-incident-side polarizer can be used to recycle the second light and the third light so that the second light and the third light are used at improved efficiency, and reduce the cost of the polarizers.

### Additional Remark 10

The optical module according to Additional Remark 5, wherein
the first light-incident-side polarizer and the first light-exiting-side polarizer are each separate from the first light modulator,
the second light-incident-side polarizer and the second light-exiting-side polarizer are each separate from the second light modulator, and
the third light-incident-side polarizer and the third light-exiting-side polarizer are each separate from the third light modulator.

According to the configuration described in Additional Remark 10, since heat generated by the polarizers is unlikely to be transferred to the respective light modulators, deterioration of the characteristics of the light modulators due to the heat can be suppressed.

### Additional Remark 11

The optical module according to Additional Remark 10, wherein
a distance between the first light-incident-side polarizer and the first light modulator and a distance between the first light-exiting-side polarizer and the first light modulator are each 13 mm or smaller,
a distance between the second light-incident-side polarizer and the second light modulator and a distance between the second light-exiting-side polarizer and the second light modulator are each 13 mm or smaller, and
a distance between the third light-incident-side polarizer and the third light modulator and a distance between the third light-exiting-side polarizer and the third light modulator are each 13 mm or smaller.

According to the configuration described in Additional Remark 11, deterioration of the characteristic of the light modulators due to the heat can be effectively suppressed.

### Additional Remark 12

The optical module according to Additional Remark 10, wherein
when viewed along an optical axis of the first light output from the first light source, the first light-incident-side polarizer and the first light-exiting-side polarizer each overlap with a first light modulation region of the first light modulator,
when viewed along an optical axis of the second light output from the second light source, the second light-incident-side polarizer and the second light-exiting-side polarizer each overlap with a second light modulation region of the second light modulator,
when viewed along an optical axis of the third light output from the third light source, the third light-incident-side polarizer and the third light-exiting-side polarizer each overlap with a third light modulation region of the third light modulator,
an area of each of the first light-incident-side polarizer and the first light-exiting-side polarizer is greater than or equal to 1.0 times but smaller than or equal to 2.0 times an area of the first light modulation region,
an area of each of the second light-incident-side polarizer and the second light-exiting-side polarizer is greater than or equal to 1.0 times but smaller than or equal to 2.0 times an area of the second light modulation region, and
an area of each of the third light-incident-side polarizer and the third light-exiting-side polarizer is greater than or equal to 1.0 times but smaller than or equal to 2.0 times an area of the third light modulation region.

According to the configuration described in Additional Remark 12, even when the three types of color light diverge out of the respective light modulation regions, the function of each of the polarizers can be reliably provided, and each of the polarizers is readily held.

### Additional Remark 13

The optical module according to Additional Remark 5, wherein
the first light-incident-side polarizer and the first light-exiting-side polarizer are each in contact with the first light modulator,
the second light-incident-side polarizer and the second light-exiting-side polarizer are each in contact with the second light modulator,
the third light-incident-side polarizer and the third light-exiting-side polarizer are each in contact with the third light modulator,
when viewed along an optical axis of the first light output from the first light source, the first light-incident-side polarizer and the first light-exiting-side polarizer each overlap with a first light modulation region of the first light modulator,
when viewed along an optical axis of the second light output from the second light source, the second light-incident-side polarizer and the second light-exiting-side polarizer each overlap with a second light modulation region of the second light modulator,
when viewed along an optical axis of the third light output from the third light source, the third light-incident-side polarizer and the third light-exiting-side polarizer each overlap with a third light modulation region of the third light modulator,
an area of each of the first light-incident-side polarizer and the first light-exiting-side polarizer is greater than or equal to 1.0 times but smaller than or equal to 1.2 times an area of the first light modulation region,
an area of each of the second light-incident-side polarizer and the second light-exiting-side polarizer is greater than or equal to 1.0 times but smaller than or equal to 1.2 times an area of the second light modulation region, and
an area of each of the third light-incident-side polarizer and the third light-exiting-side polarizer is greater than or equal to 1.0 times but smaller than or equal to 1.2 times an area of the third light modulation region.

According to the configuration described in Additional Remark 13, since distance between each of the polarizers and the corresponding light modulator is unnecessary, the optical module can be reduced in size. Furthermore, even when the three types of color light diverge out of the respective light modulation regions, the function of each of the polarizers can be reliably provided, and each of the polarizers is readily held.

### Additional Remark 14

The optical module according to Additional Remark 5, wherein
the first light guide, the second light guide, and the third light guide are each configured with a rectangular tubular frame body that expands from a light incident end toward a light exiting end of the light guide, and
an inner surface of the frame body is a light reflecting surface.

According to the configuration described in Additional Remark 14, the multiple types of color light output from the light sources via the light guides can be reliably incident on the light-incident-side polarizers.

### Additional Remark 15

The optical module according to Additional Remark 5, wherein
the first light source, the second light source, and the third light source each include a light emitting diode.

According to the configuration described in Additional Remark 15, randomly polarized light containing two polarized components can be output from each of the light sources.

What is claimed is:

1. An optical module comprising:
a first light source configured to output first light having a first wavelength band containing a first polarized component and a second polarized component;
a second light source configured to output second light having a second wavelength band different from the first wavelength band and containing a third polarized component and a fourth polarized component;
a first light guide configured to guide the first light output from the first light source and homogenize in-plane illuminance of the first light;
a second light guide configured to guide the second light output from the second light source and homogenize in-plane illuminance of the second light;
a first light-incident-side polarizer configured to transmit the second polarized component of the first light output from the first light guide;
a second light-incident-side polarizer configured to transmit the fourth polarized component of the second light output from the second light guide;
a first light modulator configured to modulate the second polarized component output from the first light-incident-side polarizer based on image information;
a second light modulator configured to modulate the fourth polarized component output from the second light-incident-side polarizer based on image information;
a first light-exiting-side polarizer configured to transmit the first polarized component but does not transmit the second polarized component out of the light modulated by the first light modulator;
a second light-exiting-side polarizer configured to transmit the third polarized component but does not transmit the fourth polarized component out of the light modulated by the second light modulator;
a light combiner configured to combine the first polarized component output from the first light-exiting-side polarizer and the third polarized component output from the second light-exiting-side polarizer with each other and output the combined light; and
a projection system configured to project the combined light output from the light combiner,
wherein the first polarized component and the third polarized component are polarized components different from each other, and
the light combiner is configured to combine the first polarized component and the third polarized component with each other based on a difference between the first polarized component and the third polarized component.

2. The optical module according to claim 1, further comprising:
a third light source configured to output third light having a third wavelength band different from the first wavelength band and the second wavelength band, the third wavelength band containing a fifth polarized component and a sixth polarized component;
a third light guide configured to guide the third light output from the third light source and homogenize in-plane illuminance of the third light;
a third light-incident-side polarizer configured to transmit the sixth polarized component of the third light output from the third light guide;
a third light modulator configured to modulate the sixth polarized component output from the third light-incident-side polarizer based on image information; and
a third light-exiting-side polarizer configured to transmit the fifth polarized component but does not transmit the sixth polarized component out of the light modulated by the third light modulator,
wherein the fifth polarized component and the third polarized component are polarized components different from each other, and
the light combiner is configured to further combine the fifth polarized component with the combined light based on a difference between the fifth polarized component and the third polarized component.

3. The optical module according to claim 2, further comprising:
a first parallelizing element configured to parallelize the first light output from the first light guide;
a second parallelizing element configured to parallelize the second light output from the second light guide; and
a third parallelizing element configured to parallelize the third light output from the third light guide.

4. The optical module according to claim 3, wherein
the first polarized component and the fifth polarized component are S-polarized light with respect to a light combining surface of the light combiner,
the third polarized component is P-polarized light with respect to the light combining surface,
the first polarized component and the fifth polarized component are reflected off the light combining surface, and
the third polarized component passes through the light combining surface.

5. The optical module according to claim 4, wherein
the first light is blue light,
the second light is green light, and
the third light is red light.

6. The optical module according to claim 5, wherein
the first light-exiting-side polarizer, the second light-exiting-side polarizer, and the third light-exiting-side polarizer are each made of an inorganic material.

7. The optical module according to claim 5, wherein
the first light-exiting-side polarizer, the second light-exiting-side polarizer, and the third light-exiting-side polarizer are each made of an organic material.

8. The optical module according to claim 5, wherein
the first light-exiting-side polarizer and the second light-exiting-side polarizer are each made of an inorganic material, and
the third light-exiting-side polarizer is made of an organic material.

9. The optical module according to claim 5, wherein
the first light-incident-side polarizer has a wire grid layer, and a light absorbing layer that is disposed on a side of the wire grid layer opposite a side on which the first light is incident, and
each of the second light-incident-side polarizer and the third light-incident-side polarizer has a reflection layer and is made of an organic material.

10. The optical module according to claim 5, wherein
the first light-incident-side polarizer and the first light-exiting-side polarizer are each separate from the first light modulator,
the second light-incident-side polarizer and the second light-exiting-side polarizer are each separate from the second light modulator, and
the third light-incident-side polarizer and the third light-exiting-side polarizer are each separate from the third light modulator.

11. The optical module according to claim 10, wherein
a distance between the first light-incident-side polarizer and the first light modulator and a distance between the first light-exiting-side polarizer and the first light modulator are each 13 mm or smaller,
a distance between the second light-incident-side polarizer and the second light modulator and a distance between the second light-exiting-side polarizer and the second light modulator are each 13 mm or smaller, and
a distance between the third light-incident-side polarizer and the third light modulator and a distance between the third light-exiting-side polarizer and the third light modulator are each 13 mm or smaller.

12. The optical module according to claim 10, wherein
when viewed along an optical axis of the first light output from the first light source, the first light-incident-side polarizer and the first light-exiting-side polarizer each overlap with a first light modulation region of the first light modulator,
when viewed along an optical axis of the second light output from the second light source, the second light-incident-side polarizer and the second light-exiting-side polarizer each overlap with a second light modulation region of the second light modulator,
when viewed along an optical axis of the third light output from the third light source, the third light-incident-side polarizer and the third light-exiting-side polarizer each overlap with a third light modulation region of the third light modulator,
an area of each of the first light-incident-side polarizer and the first light-exiting-side polarizer is greater than or equal to 1.0 times but smaller than or equal to 2.0 times an area of the first light modulation region,
an area of each of the second light-incident-side polarizer and the second light-exiting-side polarizer is greater than or equal to 1.0 times but smaller than or equal to 2.0 times an area of the second light modulation region, and
an area of each of the third light-incident-side polarizer and the third light-exiting-side polarizer is greater than or equal to 1.0 times but smaller than or equal to 2.0 times an area of the third light modulation region.

13. The optical module according to claim 5, wherein
the first light-incident-side polarizer and the first light-exiting-side polarizer are each in contact with the first light modulator,
the second light-incident-side polarizer and the second light-exiting-side polarizer are each in contact with the second light modulator,
the third light-incident-side polarizer and the third light-exiting-side polarizer are each in contact with the third light modulator,
when viewed along an optical axis of the first light output from the first light source, the first light-incident-side polarizer and the first light-exiting-side polarizer each overlap with a first light modulation region of the first light modulator,
when viewed along an optical axis of the second light output from the second light source, the second light-incident-side polarizer and the second light-exiting-side polarizer each overlap with a second light modulation region of the second light modulator,
when viewed along an optical axis of the third light output from the third light source, the third light-incident-side polarizer and the third light-exiting-side polarizer each overlap with a third light modulation region of the third light modulator,
an area of each of the first light-incident-side polarizer and the first light-exiting-side polarizer is greater than or equal to 1.0 times but smaller than or equal to 1.2 times an area of the first light modulation region,
an area of each of the second light-incident-side polarizer and the second light-exiting-side polarizer is greater than or equal to 1.0 times but smaller than or equal to 1.2 times an area of the second light modulation region, and
an area of each of the third light-incident-side polarizer and the third light-exiting-side polarizer is greater than or equal to 1.0 times but smaller than or equal to 1.2 times an area of the third light modulation region.

14. The optical module according to claim 5, wherein
the first light guide, the second light guide, and the third light guide are each configured with a rectangular tubular frame body that expands from a light incident end toward a light exiting end of the light guide, and
an inner surface of the frame body is a light reflecting surface.

15. The optical module according to claim 5, wherein
the first light source, the second light source, and the third light source each include a light emitting diode.
